(19) United States
(12) Patent Application Publication
(10) Pub. No.: US 2009/0227372 A1
(43) Pub. Date: Sep. 10, 2009

(54) Aim Assisting Apparatus

(76) Inventor: Hung Shan Yang, Taipei City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/043,215

(22) Filed: Mar. 6, 2008

(51) Int. Cl. A63F 13/02

(52) U.S. Cl. 463/36

(57) ABSTRACT

An aim assisting apparatus includes an image capturing device adapted to secure under a barrel of a handgun held by one hand, a front laser guiding unit, a camera and image storage unit, and a wireless transmitting unit; and a video playing device worn on the other hand and comprising an image signal receiving unit, an image signal processing unit, and a display. The laser guiding unit emits light toward a target, the light is reflected to be received and stored as an image, an image signal is sent from the wireless transmitting unit to the image signal receiving unit, the image signal processing unit processes the image signal sent from the image signal receiving unit into an image, and the image is shown on the display. A reticle on the display is adapted to move to superimpose itself over the image representing the target by moving the handgun.

### BACKGROUND OF THE INVENTION

1. Field of Invention

The invention relates to aim assisting equipment and more particularly to an aim assisting apparatus including a laser guided image capturing device mounted under a handgun held by one hand, and a video playing device fastened at the other hand so that a police office can easily precisely aim a criminal in a safe operating mode during gun fighting.

2. Description of Related Art

It is not uncommon for a law enforcement officer (e.g., police officer) to engage a gun fight with criminal(s). A police officer may hold a handgun with one or two hands, aim a criminal, and shoot. However, this stance has a disadvantage. That is, the body of the police officer is almost completely exposed. While it can increase the probability of hitting the target (i.e., the criminal), it also risks the possibility of being shot by the criminal.

Thus, a police officer may hide his body when shooting for safety reasons. However, the probability of hitting a criminal is decreased significantly due to view blocking in this stance.

Therefore, a device for assisting aim by guiding a handgun while decreasing the probability of being shot by a criminal is desired.

### SUMMARY OF THE INVENTION

It is therefore one object of the invention to provide an aim assisting apparatus comprising an image capturing device comprising a top mounting member adapted to secure under a barrel of a handgun held by one hand, a front laser guiding unit, a camera and image storage unit, and a wireless transmitting unit; a video playing device comprising an image signal receiving unit, an image signal processing unit, wearing means, a display, and a control panel; and a strap secured to the wearing means and being adapted to fasten around the other hand, wherein the laser guiding unit is adapted to emit a light beam toward a target, the light beam is reflected from the target to be received and stored as an image, the image in the form of signal is sent from the wireless transmitting unit to the image signal receiving unit, the image signal processing unit processes the image signal sent from the image signal receiving unit into an image, and the image is shown on the display; and wherein a reticle shown on the display is adapted to move to superimpose a center of the reticle over the image representing the target by moving the handgun.

The above and other objects, features and advantages of the invention will become apparent from the following detailed description taken with the accompanying drawings.

### BRIEF DESCRIPTION OF THE DRAWINGS

FIG. 1 is a perspective view of an image capturing device as a part of an aim assisting apparatus according to the invention;

FIG. 2 is a perspective view of the image capturing device mounted under the barrel of a handgun;

FIG. 3 is a perspective view of a video playing device as the other part of the aim assisting apparatus according to the invention; and

FIG. 4 is a schematic environmental view of the aim assisting apparatus where the image capturing device is mounted under the barrel of a handgun which is held by one hand of a police officer, and the video playing device is fastened on the wrist of the other hand.

### DETAILED DESCRIPTION OF THE INVENTION

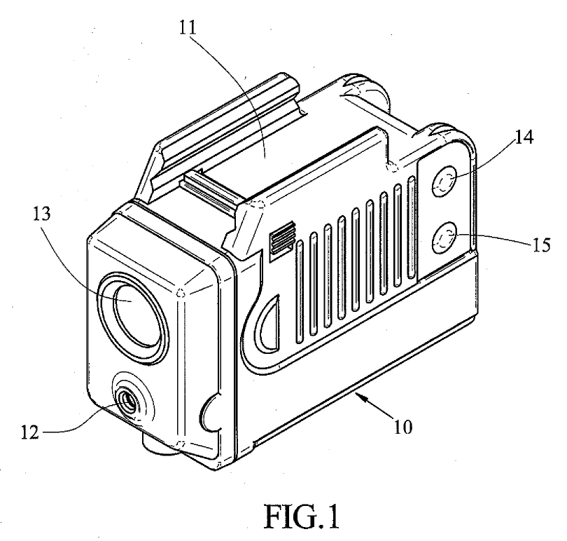

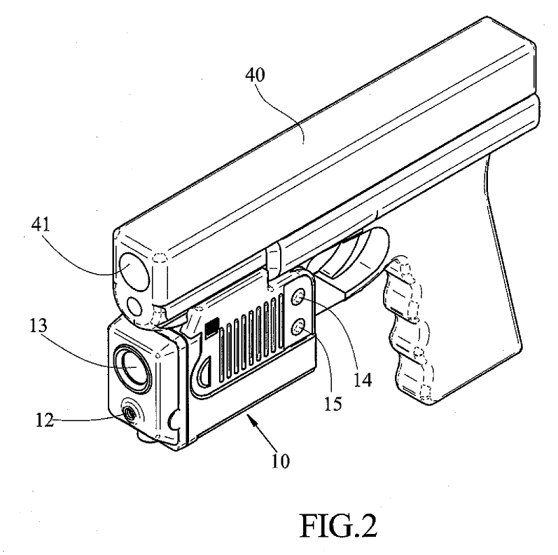

Referring to FIGS. 1 and 2, an aim assisting apparatus in accordance with of the invention is illustrated. The aim assisting apparatus comprises an image capturing device 10 and a video playing device 20. Each component is discussed in detail below.

The substantially parallelepiped image capturing device 10 comprises a top mounting member 11 shaped as grooved rails (note that the mounting member 11 may be shaped as another different size and shape in other embodiments), a front infrared (IR) laser guiding unit 12, a lens 13 above the IR laser guiding unit 12 wherein the lens 13 together with an image storage store (not shown) forming a camera and image storage unit), a wireless transmitting unit (not shown) for transmitting the stored image signals to the video playing device 20, an on/off switch 14 on one side for turning on or off the IR laser guiding unit 12, and a selector 15 below the switch 14 for selecting between visible light and invisible light operating modes.

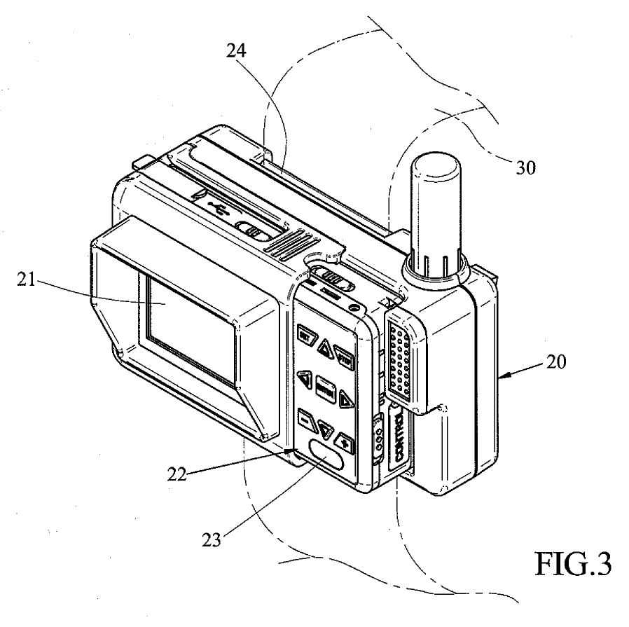

Referring to FIG. 3, the substantially parallelepiped video playing device 20 comprises an antenna (not numbered) as a part of an image signal receiving unit (not shown) for receiving image signals sent from the image capturing device 10, an image signal processing unit (not shown), upper and lower bars (only the upper bar 24 being shown) spaced from the other side (i.e., there is a gap between either bar and the body of the video playing device 20), a display (e.g., liquid crystal display (LCD) display) 21 on one side, and a control panel 22 beside the display 21 on the same side. A user may press key(s) 23 on the control panel 22 to adjust parameters (e.g., brightness, hue, etc.) of the display 21. A strap 30 has one end secured to the upper bar 24 and the other end secured to the lower bar respectively. In one embodiment, both end portions of the strap 30 are implemented as Velcro fasteners.

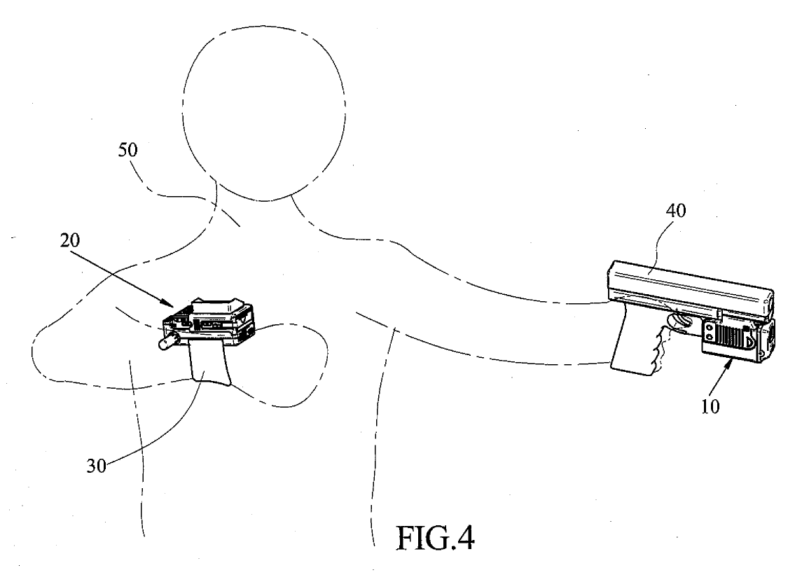

Referring to FIG. 4 in conjunction with FIGS. 1 to 3, an assembly of the invention is described below. First, a police officer 50 mount the mounting member 11 under the barrel (not numbered) of a handgun 40 with both the lens 13 and the IR laser guiding unit 12 disposed below the muzzle 41 of the handgun 40. That is, the muzzle 41, the lens 13, and the IR laser guiding unit 12 face forward. The police officer 50 uses one hand to hold the grip of the handgun 40. Also, the police officer 50 wraps the strap 30 around the other hand and fastens.

An operation of the invention is further described below. The image capturing device 10 serves as sight of a conventional handgun. The selector 15 is switched to select a visible light operating mode. The IR laser guiding unit 12 emits a light beam toward a target (e.g., criminal). The light beam is reflected from the target to be received by the image storage store through the lens 13. The received light beam is converted into an image signal of the target and is stored in the image storage store of the 10. Next, the image signal is sent to the antenna of the image signal receiving unit of the video playing device 20 from the wireless transmitting unit of the image capturing device 10. The image signal processing unit of the video playing device 20 processes the image signal sent from the antenna into images which are shown on the display 21. A reticle is shown on the center of the display 21. The police officer may move the handgun 40 (i.e., the image capturing device 10) for adjustment by viewing the display 21 until the center point of the reticle is superimposed over the target. It is designed that a bullet fired by the handgun 40 right now will precisely hit the target. Thus, this operating mode has the benefits of quickly aiming the target and greatly reducing the body of the police officer being exposed to the criminal (i.e., safety of the police officer being greatly increased) when engaging a gun fight with criminal(s).

Alternatively, in the invisible light operating mode (i.e., light beam emitted by the IR laser guiding unit 12 being invisible) the target is not aware of himself being aimed by a police officer. But, the target is clearly shown on the display 21. This operating mode can be implemented as a preparatory step of the visible light operating mode.

Preferably, the wireless transmitting unit of the image capturing device 10 is implemented as an RF (radio frequency) transmitter, a Bluetooth transmitter, a Wi-Fi transmitter, a 3G (third generation) transmitter, or a GSM (Global System for Mobile Communications) transmitter.

Preferably, the image signal receiving unit is implemented as an RF receiver, a Blue-tooth receiver, a Wi-Fi receiver, a 3G receiver, or a GSM receiver.

Preferably, the video playing device 20 further comprises indicators for indicating the states of image signals being received.

Moreover, a team operation of the invention is also possible. In detail, each member of a police squad is equipped with the aim assisting apparatus of the invention. The aiming condition of each member can be transmitted to the squad leader. Thus, after viewing the display the leader is able to command any members by means of a wireless microphone when such need arises.

While the invention herein disclosed has been described by means of specific embodiments, numerous modifications and variations could be made thereto by those skilled in the art without departing from the scope and spirit of the invention set forth in the claims.

What is claimed is:

1. An aim assisting apparatus comprising:
an image capturing device comprising a top mounting member adapted to secure under a barrel of a handgun held by one hand, a front laser guiding unit, a camera and image storage unit, and a wireless transmitting unit;
a video playing device comprising an image signal receiving unit, an image signal processing unit, wearing means, a display, and a control panel; and
a strap secured to the wearing means and being adapted to fasten around the other hand,
wherein the laser guiding unit is adapted to emit a light beam toward a target, the light beam is reflected from the target to be received and stored as an image, the image in the form of signal is sent from the wireless transmitting unit to the image signal receiving unit, the image signal processing unit processes the image signal sent from the image signal receiving unit into an image, and the image is shown on the display; and
wherein a reticle shown on the display is adapted to move to superimpose a center of the reticle over the image representing the target by moving the handgun.

2. The aim assisting apparatus of claim 1, wherein the camera and image storage unit comprises a lens and an image storage store.

3. The aim assisting apparatus of claim 1, wherein the laser guiding unit is an infrared (IR) laser guiding unit, and wherein the image capturing device further comprises an on/off switch for turning on or off the IR laser guiding unit, and a selector for selecting between visible light and invisible light operating modes

4. The aim assisting apparatus of claim 1, wherein the laser guiding unit and a portion of the camera and image storage unit are disposed directly below a muzzle of the handgun and face forward.

5. The aim assisting apparatus of claim 1, wherein the top mounting member is implemented as one of a plurality of different sizes to be adapted to secure under the barrel of the handgun.

6. The aim assisting apparatus of claim 1, wherein the wireless transmitting unit is an RF (radio frequency) transmitter and the image signal receiving unit is an RF receiver.

7. The aim assisting apparatus of claim 1, wherein the wireless transmitting unit is a Bluetooth transmitter and the image signal receiving unit is a Bluetooth receiver.

8. The aim assisting apparatus of claim 1, wherein the wireless transmitting unit is a Wi-Fi transmitter and the image signal receiving unit is a Wi-Fi receiver.

9. The aim assisting apparatus of claim 11 wherein the wireless transmitting unit is a 3G (third generation) transmitter and the image signal receiving unit is a 3G receiver.

10. The aim assisting apparatus of claim 1, wherein the wireless transmitting unit is a GSM (Global System for Mobile Communications) transmitter and the image signal receiving unit is a GSM receiver.

11. The aim assisting apparatus of claim 1, wherein the strap is a Velcro fastener.

12. The aim assisting apparatus of claim 1, wherein the display is an LCD display.

13. The aim assisting apparatus of claim 1, wherein the control panel is disposed beside the display.

14. The aim assisting apparatus of claim 1, wherein the video playing device further comprises a plurality of indicators for indicating the states of the image signals being received.
